(19) United States
(12) Patent Application Publication
(10) Pub. No.: US 2025/0189733 A1
(43) Pub. Date: Jun. 12, 2025

(54) OPTOELECTRONIC MODULE AND METHOD FOR OPERATING AN OPTOELECTRONIC MODULE

(71) Applicant: ams-OSRAM International GmbH, Regensburg (DE)

(72) Inventor: Daniel RICHTER, Bad Abbach (DE)

(73) Assignee: ams-OSRAM International GmbH, Regensburg (DE)

(21) Appl. No.: 18/847,181

(22) PCT Filed: Mar. 7, 2023
(86) PCT No.: PCT/EP2023/055711

§ 371 Date: Sep. 13, 2024

(30) Foreign Application Priority Data
Mar. 17, 2022 (DE) 10 2022 106 271.6

(51) Int. Cl. G02B 6/42

(52) U.S. Cl. CPC G02B 6/4215; G02B 6/421

(57) ABSTRACT

The invention relates to an optoelectronic module including a semiconductor component designed to emit electromagnetic radiation; a distribution structure having a plurality of distribution elements, at least one input waveguide and a plurality of output waveguides; and a plurality of conversion structures. The electromagnetic radiation emitted by the semiconductor component enters the distribution structure through the input waveguide. The electromagnetic radiation exits the distribution structure through the output waveguide. One conversion structure is arranged downstream of each output waveguide. The invention also relates to a method for operating an optoelectronic module.

### CROSS-REFERENCE TO RELATED APPLICATIONS

The present application is a national stage entry from International Application No. PCT/EP2023/055711, filed on Mar. 7, 2023, published as International Publication No. WO 2023/174752 A1 on Sep. 21, 2023, and claims priority to German Patent Application No. 10 2022 106 271.6, filed Mar. 17, 2022, the disclosures of all of which are hereby incorporated by reference in their entireties.

### FIELD

An optoelectronic module and a method for operating an optoelectronic module are disclosed. The optoelectronic module is in particular configured to generate electromagnetic radiation, for example light perceptible to the human eye.

### BACKGROUND

One task to be solved is to specify an optoelectronic module which has a plurality of output waveguides with a particularly high luminance.

A further task to be solved is to specify a method for operating an optoelectronic module which enables simplified control of a plurality of output waveguides.

These tasks are solved by the device and the methods according to the independent patent claims. Advantageous embodiments and further embodiments of the device are the subject of the dependent patent claims and are further apparent from the following description and the figures.

### SUMMARY

According to at least one embodiment, the optoelectronic module comprises a semiconductor component configured to emit electromagnetic radiation. The electromagnetic radiation preferably comprises a spectral distribution with a main wavelength in the visible spectral range. Here and in the following, a main wavelength is a wavelength of electromagnetic radiation at which a spectrum of the radiation has a global maximum.

The semiconductor component comprises, for example, at least one semiconductor emitter. In particular, the semiconductor emitter comprises a first region of a first conductivity, a second region of a second conductivity and an active region which is configured to emit electromagnetic radiation. Advantageously, the first conductivity differs from the second conductivity. For example, the first region and the second region are each formed with a doped semiconductor material. In particular, the active region has a pn junction, a double heterostructure, a single quantum well structure (SQW) or a multi-quantum well structure (MQW) for the generation of radiation. The semiconductor emitter is, for example, a luminescence diode, in particular a luminaire or laser diode.

According to at least one embodiment, the optoelectronic module comprises a distribution structure comprising a plurality of distribution elements, at least one input waveguide and a plurality of output waveguides. The distribution structure comprises, for example, a planar waveguide structure. Preferably, the distribution elements, the at least one input waveguide and the output waveguides are monolithically integrated on a substrate. This enables a particularly compact design with advantageously low optical coupling losses.

In particular, the distribution structure is configured to distribute electromagnetic radiation from the at least one input waveguide to the output waveguides in a predetermined intensity ratio. The electromagnetic radiation coupled into the distribution structure can thus emerge from the output waveguides in a desired ratio. The distribution elements are provided, for example, in the form of optical switches. Preferably, each distribution element comprises an input and at least two outputs. In particular, each distribution element influences a distribution of the radiation intensity of electromagnetic radiation entering through the input to the outputs.

According to at least one embodiment, the optoelectronic module comprises a plurality of conversion structures. In particular, a conversion structure is configured to convert electromagnetic radiation of a first wavelength to electromagnetic radiation of a second wavelength different from the first wavelength. The conversion structure effects, for example, a partial or complete conversion of the incoming electromagnetic radiation. In particular, the conversion structure converts part of the electromagnetic radiation entering it and consequently emits mixed radiation. Advantageously, the mixed radiation causes a white color impression in an observer.

According to at least one embodiment of the optoelectronic module, the electromagnetic radiation emitted by the semiconductor component enters the distribution structure through the input waveguide. The input waveguide advantageously has a core region and a cladding region. The cladding region at least partially surrounds the core region. The core region advantageously has a higher refractive index than the cladding region.

According to at least one embodiment of the optoelectronic module, the electromagnetic radiation exits the distribution structure through the output waveguides. A desired distribution of the electromagnetic radiation can be set at the output waveguides. For example, the electromagnetic radiation exits from each output waveguide in one exit direction. Preferably, the exit directions of all output waveguides are aligned parallel to each other.

According to at least one embodiment of the optoelectronic module, a conversion structure is arranged downstream of each output waveguide. An arrangement of one conversion structure on each output waveguide enables a particularly high contrast ratio between neighboring conversion structures.

According to at least one embodiment, the optoelectronic module comprises:
a semiconductor component configured to emit electromagnetic radiation,
a distribution structure comprising a plurality of distribution elements, at least one input waveguide and a plurality of output waveguides, and
a plurality of conversion structures, whereby
the electromagnetic radiation emitted by the semiconductor component enters the distribution structure through the input waveguide,
the electromagnetic radiation exits the distribution structure through the output waveguides,
a conversion structure is arranged downstream of each output waveguide.

An optoelectronic module described here is based on the following considerations, among others: To produce pixelated light sources with high luminance, several individual semiconductor components can be arranged next to each other in an array. To emit white light, a converter element can be arranged downstream of each semiconductor component. However, such an arrangement makes effective cooling of the semiconductor components and the converter elements more difficult, as waste heat is generated both in the semiconductor components and in the converter elements during operation. This can limit the maximum achievable luminance of the individual semiconductor components. Furthermore, a precise arrangement of a plurality of semiconductor components in an array can be associated with increased manufacturing costs.

The optoelectronic module described here makes use, among other things, of the idea of spatially separating the generation of electromagnetic radiation from the conversion of the electromagnetic radiation. Furthermore, by using a distribution structure, only one semiconductor component is required to control a plurality of emission areas. Electromagnetic radiation generated in the semiconductor component is coupled into the distribution structure and distributed there to a plurality of output waveguides. Each output waveguide is followed by a conversion structure that converts at least part of the electromagnetic radiation. Due to the spatial separation between the semiconductor component and the conversion structures, the two structures can be cooled separately. Advantageously, the semiconductor component and the conversion structures can thus work at different operating temperatures. Furthermore, a plurality of conversion structures can be controlled with just one semiconductor component. A time-consuming adjustment of a plurality of semiconductor components in an array can be advantageously avoided.

According to at least one embodiment of the optoelectronic module, the distribution elements are passive and wavelength-selective filter elements. For example, the distribution elements are designed as Mach-Zehnder interferometers, dielectric interference thin-film filters, waveguide grating routers or microring resonators. Advantageously, passive distribution elements do not require any additional control. The distribution elements are configured to select electromagnetic radiation according to its main wavelength. In particular, a distribution of the output characteristic of a distribution element can be set, for example, by an electric field applied constantly during operation at a beam splitter or a constantly set phase shift at a Mach-Zehnder interferometer. In this way, for example, manufacturing-related deviations in the distribution elements can be compensated for. Here and in the following, distribution elements with such a static correction during operation are also to be regarded as passive filter elements, as they do not require actively modulated control during operation.

According to at least one embodiment of the optoelectronic module, the distribution elements have a passband with a bandwidth of at most 2 nm, preferably at most 1 nm. In particular, the distribution elements have a high radiation permeability in the passband. For example, electromagnetic radiation outside the passband is reflected or absorbed by the distribution element. A low bandwidth makes it possible to control an advantageously high number of distribution elements with a semiconductor component that emits electromagnetic radiation with a delimiting bandwidth.

According to at least one embodiment of the optoelectronic module, the semiconductor component is configured to emit coherent radiation with a modulatable main wavelength. By modulating the main wavelength, a distribution of the electromagnetic radiation can be influenced by the wavelength-selective distribution structure. In particular, the semiconductor component comprises a laser component with a sampled grating and a distributed Bragg reflector (sample grating distributed Bragg reflector laser, SG-DBR for short). Alternatively, the semiconductor component is formed with a laser component with an external resonator.

According to at least one embodiment of the optoelectronic module, the main wavelength of the electromagnetic radiation emitted by the semiconductor component can be modulated in a spectral range over a bandwidth of at least 25 nm, preferably of at least 50 nm and particularly preferably of at least 100 nm, wherein the spectral range includes a wavelength of 447 nm. Preferably, the semiconductor component emits coherent electromagnetic radiation. In particular, the semiconductor component emits electromagnetic radiation with a main wavelength between 390 nm and 480 nm.

According to at least one embodiment of the optoelectronic module, the main wavelength can be modulated with a frequency of at least 500 Hz, preferably at least 1 kHz and particularly preferably at least 2 kHz. A high modulation frequency enables an advantageously short time span in which a specific main wavelength can be emitted. In particular, a high modulation frequency also increases the number of different main wavelengths that can be provided in a given display period. Consequently, the number of controllable distribution elements and output waveguides can be increased.

A display period here and in the following describes a period of time in which a desired intensity distribution of the electromagnetic radiation is provided at the output waveguides. Advantageously, the display period is so short that no impression of flickering is created for a human observer. For example, the display period is at most 1/30 s, preferably at most 1/60 s and particularly preferably at most 1/100 s.

According to at least one embodiment of the optoelectronic module, the semiconductor component comprises at least two semiconductor emitters, wherein the first semiconductor emitter is configured to emit electromagnetic radiation with a variable main wavelength in a first spectral range and a second semiconductor emitter is configured to emit electromagnetic radiation with a variable main wavelength in a second spectral range. In particular, the first main wavelength is different from the second main wavelength. For example, the spectral ranges of the first electromagnetic radiation and the second electromagnetic radiation do not overlap. By using multiple semiconductor emitters, the semiconductor component can emit electromagnetic radiation over a wider bandwidth.

According to at least one embodiment of the optoelectronic module, an input waveguide is assigned to each semiconductor emitter. Advantageously, a required number of distribution elements can thus be reduced. For example, a first semiconductor emitter is assigned a first number of output waveguides and a second semiconductor emitter is assigned a second number of output waveguides. Advantageously, the first main wavelength of the first semiconductor emitter is identical to the second main wavelength of the second semiconductor emitter.

According to at least one embodiment of the optoelectronic module, each output waveguide is assigned exactly one distribution element. Advantageously, only as many distribution elements as output waveguides are required. In particular, each distribution element is configured to control exactly one output waveguide.

According to at least one embodiment of the optoelectronic module, the distribution elements are active and controllable coupling elements. Active distribution elements are advantageously particularly precisely controllable. For example, the distribution elements are designed as controllable directional couplers or as controllable directional couplers with phase reversal. In particular, each distribution element comprises a Mach-Zehnder interferometer. Advantageously, the distribution elements are designed as electro-optically controllable components. In other words, an intensity distribution on the outputs of a distribution element can be adjusted by means of an electrical control signal. In particular, a control line is assigned to each distribution element.

According to at least one embodiment of the optoelectronic module, the distribution elements can be modulated with a frequency of at least 0.5 GHz, preferably 1 GHz, particularly preferably 10 GHz. Modulation of a distribution element is defined here and in the following as a complete switching process. A particularly high modulation frequency enables an advantageously increased number of output waveguides that can be controlled within a predetermined display period.

According to at least one embodiment of the optoelectronic module, the semiconductor component is configured to emit coherent radiation with a main wavelength in the blue spectral range. In particular, the main wavelength is greater than or equal to 450 nm and less than or equal to 475 nm. A main wavelength in the blue spectral range is particularly suitable for generating white mixed light.

According to at least one embodiment of the optoelectronic module, each conversion structure comprises an output coupling element. The output coupling element is, for example, an optical grating coupler. Grating couplers enable an advantageously high efficiency with which electromagnetic radiation is coupled out from a waveguide into a region.

According to at least one embodiment of the optoelectronic module, each conversion structure comprises a diffuser element. The diffuser element is preferably arranged downstream of the output coupling element. In particular, the diffuser element homogenizes electromagnetic radiation emerging from the output coupling element. For example, the diffuser element has a large number of small scattering centers. If parallel light rays hit different points on the diffuser element, they are distributed in different directions and thus generate diffuse light.

According to at least one embodiment of the optoelectronic module, an input coupling element is assigned to each input waveguide. The input coupling element is, for example, a grating coupler. In particular, the input coupling element enables improved coupling efficiency between the semiconductor component and an input waveguide.

According to at least one embodiment of the optoelectronic module, the semiconductor component is formed with a III/V compound semiconductor material. A III/V compound semiconductor material has at least one element from the third main group, such as B, Al, Ga, In, and one element from the fifth main group, such as N, P, As. In particular, the term “III/V compound semiconductor material” comprises the group of binary, ternary or quaternary compounds which contain at least one element from the third main group and at least one element from the fifth main group, for example nitride and phosphide compound semiconductors. Such a binary, ternary or quaternary compound may also have, for example, one or more dopants and additional components. Preferably, at least the active regions of the semiconductor component are formed with a III/V compound semiconductor material. In particular, the semiconductor component also comprises other materials, for example in the form of metallizations and/or carrier materials.

Preferably, the semiconductor component is based on a phosphide compound semiconductor material. “Based on phosphide compound semiconductor material” in this context means that the semiconductor component or at least a part thereof, particularly preferably at least the active region and/or a growth substrate wafer, preferably comprises Alₙ Gaₘ In₁₋ₙ₋ₘ P or Asₙ Gₐₘ In₁₋ₙ₋ₘ P, where 0≤n≤1, 0≤m≤1 and n+m≤1. This material does not necessarily have to have a mathematically exact composition according to the above formula. Rather, it can have one or more dopants as well as additional components. For the sake of simplicity, however, the above formula only includes the essential components of the crystal lattice (Al or As, Ga, In, P), even if these may be partially replaced by small amounts of other substances. For example, the semiconductor component is formed with InGaAsP.

According to at least one embodiment of the optoelectronic module, the distribution structure is formed with one of the following materials: III/V compound semiconductor material, silicon on an insulator (silicon-on-insulator, or SOI for short), silicon dioxide, silicon nitride, indium phosphide, gallium arsenide, diamond, diamond on an insulator (diamond-on-insulator, or DOI for short), lithium niobate, aluminum oxide, aluminum nitride, gallium nitride. Preferably, the distribution structure is formed with the same material as the semiconductor component. Advantageously, no refractive index jump occurs between the semiconductor component and the distribution structure.

According to at least one embodiment of the optoelectronic module, the optoelectronic module comprises at least 10, preferably at least 30, particularly preferably at least 100 output waveguides. An increased number of output waveguides increases an achievable resolution of the optoelectronic module. For example, the optoelectronic module comprises at most 200 output waveguides.

A method for operating an optoelectronic module is further disclosed. In particular, the optoelectronic module can be operated by means of the method described herein. This means that all features disclosed in connection with the optoelectronic module are also disclosed for the method for operating an optoelectronic module and vice versa.

According to at least one embodiment of the method for operating an optoelectronic module, the distribution elements are provided as passive and wavelength-selective filter elements. For example, the distribution elements are designed as Mach-Zehnder interferometers, as dielectric interference thin-film filters, as waveguide grating routers or as microring resonators. Advantageously, passive distribution elements do not require any additional control. The distribution elements select electromagnetic radiation according to its main wavelength. In particular, the distribution elements transmit electromagnetic radiation with a main wavelength in a passband and absorb or reflect electromagnetic radiation in the spectral range outside the passband.

According to at least one embodiment of the method for operating an optoelectronic module, the semiconductor component emits electromagnetic radiation with different discrete main wavelengths. In particular, the discrete main wavelengths each correspond to a passband of a distribution element. The main wavelength of the electromagnetic radiation determines through which distribution element the electromagnetic radiation can be transmitted. In other words, a distribution element is assigned to each main wavelength.

According to at least one embodiment of the method for operating an optoelectronic module, different main wavelengths are emitted in a display period for a time period dependent on the main wavelength in each case. The emission of electromagnetic radiation of a specific main wavelength for a period of time dependent on the main wavelength enables a desired intensity distribution of the electromagnetic radiation at the output waveguides.

According to at least one embodiment of the method for operating an optoelectronic module, an optical output power of the semiconductor component is constant in the display period. This enables particularly simple control of the semiconductor component.

According to at least one embodiment of the method for operating an optoelectronic module, different main wavelengths are emitted in a display period for an identical period in each case. Advantageously, the main wavelength can be changed at a constant rate.

According to at least one embodiment of the method for operating an optoelectronic module, an optical output power of the semiconductor component is modulated in the display period in synchronization with the modulation of the main wavelengths. A desired intensity distribution at the output waveguides can thus be achieved by modulating the output power of the semiconductor component.

According to at least one embodiment of the method for operating an optoelectronic module, the distribution elements (210) are provided as active and controllable coupling elements. Active distribution elements are advantageously particularly precisely controllable. For example, the distribution elements are designed as controllable directional couplers or as controllable directional couplers with phase reversal. In particular, each distribution element comprises a Mach-Zehnder interferometer. Advantageously, the distribution elements are designed as electro-optically controllable components. In other words, an intensity distribution on the outputs of a distribution element is set by means of an electrical control signal. In particular, a control line is assigned to each distribution element. According to at least one embodiment of the method for operating an optoelectronic module, the semiconductor component emits electromagnetic radiation with a constant main wavelength. This enables a particularly simple design of the semiconductor component.

According to at least one embodiment of the method for operating an optoelectronic module, an optical output power of the semiconductor component is constant in a display period. The control of the semiconductor component is consequently simplified.

According to at least one embodiment of the method for operating an optoelectronic module, the distribution elements act as variably modulatable beam splitters whose distribution is constant over the display period. In particular, the distribution elements can effect any desired distribution of the optical power entering them to the outputs. A constant distribution over the display period enables an advantageously low requirement for a minimum switching time of the distribution elements and simplifies their control.

According to at least one embodiment of the method for operating an optoelectronic module, the distribution elements act as optical switches and are switched several times in a display period. Here and in the following, a switch is understood to be a component with ideally only two switching states. A distribution element can thus distribute the entire incoming electromagnetic radiation either to a first output or to a second output. This enables simplified control of the distribution elements.

According to at least one embodiment of the method for operating an optoelectronic module, an optical output power of the semiconductor component is modulated synchronously with the distribution elements in the display period. A modulation of the optical output power of the semiconductor component enables a representation of a desired intensity distribution at the output waveguides when optical switches are used as distribution elements.

An optoelectronic module described here is particularly suitable for use as pixelated light sources with a high luminance. In particular as headlights for motor vehicles.

Further advantages and advantageous configurations and further embodiments of the optoelectronic module result from the following exemplary embodiments shown in connection with the figures.

### BRIEF DESCRIPTION OF THE DRAWINGS

FIG. 1 a schematic sectional view of an optoelectronic module described here according to a first exemplary embodiment,

FIG. 2 a schematic sectional view of an optoelectronic module described here according to a second exemplary embodiment,

FIG. 3 a schematic top view of an optoelectronic module described here according to a third exemplary embodiment,

FIG. 4 a schematic top view of an optoelectronic module described here according to a fourth exemplary embodiment,

FIG. 5 a perspective schematic sectional view of an optoelectronic module described here according to a fifth exemplary embodiment,

FIG. 6 a control concept of an optoelectronic module described here according to a first exemplary embodiment,

FIG. 7 a control concept of an optoelectronic module described here according to a second exemplary embodiment,

FIG. 8 a schematic sectional view of a conversion structure described here according to a first exemplary embodiment,

FIG. 9 a schematic sectional view of a conversion structure described here according to a second exemplary embodiment,

FIG. 10 a schematic sectional view of a conversion structure described here according to a third exemplary embodiment,

FIG. 11 a schematic sectional view of a conversion structure described here according to a fourth exemplary embodiment,

FIG. 12 a schematic sectional view of an optoelectronic module described here according to a sixth exemplary embodiment,

FIG. 13A a schematic top view of an optoelectronic module described herein according to a seventh embodiment,

FIG. 13B a schematic sectional view of an optoelectronic module described herein according to the seventh embodiment,

FIG. 14 a schematic top view of an optoelectronic module described here according to an eighth exemplary embodiment,

FIG. 15 a schematic top view of an optoelectronic module described here according to a ninth exemplary embodiment,

FIG. 16 a schematic sectional view of a device with a plurality of optoelectronic modules described herein according to a tenth exemplary embodiment,

FIG. 17 a control concept of an optoelectronic module described here according to a third exemplary embodiment, and

FIG. 18 a control concept of an optoelectronic module described here according to a fourth exemplary embodiment.

### DETAILED DESCRIPTION

Elements that are identical, similar or have the same effect are marked with the same reference signs in the figures. The figures and the proportions of the elements shown in the figures are not to be regarded as being to scale. Rather, individual elements may be shown in exaggerated size for better visualization and/or better comprehensibility.

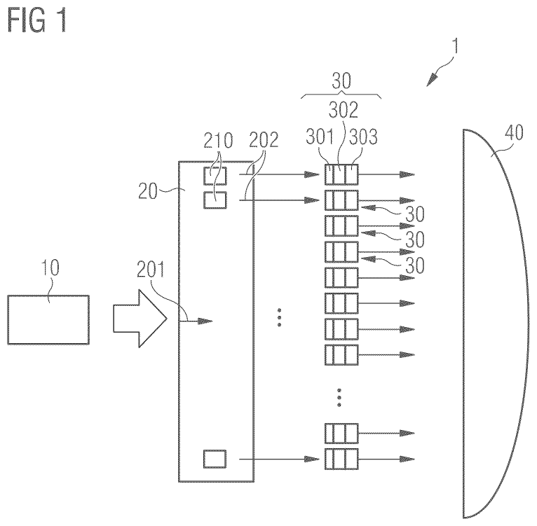

FIG. 1 shows a schematic sectional view of an optoelectronic module 1 described herein according to a first exemplary embodiment. The optoelectronic module 1 comprises a semiconductor component 10 configured to emit electromagnetic radiation. The electromagnetic radiation preferably comprises a spectral distribution with a main wavelength in the visible spectral range.

In particular, the semiconductor component 10 is configured to emit coherent radiation with a modulatable main wavelength λ₁ to λₙ. In particular, the semiconductor component 10 comprises a laser component with a sampled grating and a distributed Bragg reflector (SG-DBR). Alternatively, the semiconductor component 10 is formed with a laser component with an external resonator.

The main wavelength λ₁ to λₙ of the electromagnetic radiation emitted by the semiconductor component 10 can be modulated in a spectral range over a bandwidth of at least 25 nm, preferably of at least 50 nm and particularly preferably of at least 100 nm, wherein the spectral range includes a wavelength of 447 nm. In particular, the semiconductor component 10 emits electromagnetic radiation with a main wavelength λ₁ to λₙ between 390 nm and 480 nm.

The main wavelength λ₁ to λₙ can be modulated with a frequency of at least 500 Hz, preferably at least 1 kHz and particularly preferably at least 2 kHz. A high modulation frequency enables an advantageously short period of time in which a specific main wavelength can be emitted. In particular, a high modulation frequency also increases the number of different main wavelengths λ₁ to λₙ that can be provided in a given display period TD.

Furthermore, the optoelectronic module 1 comprises at least one distribution structure 20 with a plurality of passive and wavelength-selective distribution elements 210, at least one input waveguide 201 and a plurality of output waveguides 202. The distribution structure 20 comprises a planar waveguide structure. This enables a particularly compact design with advantageously low optical coupling losses. The distribution structure 20 is configured to distribute electromagnetic radiation from the at least one input waveguide 201 to the output waveguides 202 in a predetermined intensity ratio. The electromagnetic radiation emitted by the semiconductor component 10 enters the distribution structure 20 through the input waveguide 201. The electromagnetic radiation then exits the distribution structure 20 through the output waveguide 202. Exactly one distribution element 210 is assigned to each output waveguide 202. Advantageously, only as many distribution elements 210 as output waveguides 202 are required. Each distribution element 210 is configured to control exactly one output waveguide 202.

The distribution elements 210 are designed as Mach-Zehnder interferometers, dielectric interference thin-film filters, waveguide grating routers or microring resonators. Advantageously, passive distribution elements 210 do not require any additional control. The distribution elements 210 are configured to select electromagnetic radiation according to their main wavelength λ₁ to λₙ. In other words, each distribution element 210 is assigned to a main wavelength λ₁ to λₙ. The distribution elements 210 have a spectral passband with a bandwidth of at most 2 nm, preferably at most 1 nm. In particular, the distribution elements 210 have a high radiation permeability in the passband. For example, electromagnetic radiation outside the passband is reflected or absorbed by the distribution element 210. A low bandwidth makes it possible to control an advantageously high number of distribution elements 210 with a semiconductor component 10 that emits electromagnetic radiation with a delimiting bandwidth.

Furthermore, the optoelectronic module 1 comprises a plurality of conversion structures 30. The conversion structures 30 are arranged downstream of the distribution structure 20. The conversion structures 30 are configured to convert electromagnetic radiation of a first wavelength to electromagnetic radiation of a second wavelength different from the first wavelength. The conversion structures 30 effect, for example, a partial or complete conversion of the incoming electromagnetic radiation.

Each conversion structure 30 comprises an output coupling element 301, a diffuser element 302 and a conversion element 303. The output coupling element 301 is an optical grating coupler. Grating couplers enable an advantageously high efficiency with which electromagnetic radiation is coupled out of a waveguide into a region.

The diffuser element 302 is arranged downstream of the output coupling element 301. In particular, the diffuser element 302 homogenizes electromagnetic radiation emerging from the output coupling element 301. For example, the diffuser element 302 has a large number of small scattering centers. If parallel light rays hit different points of the diffuser element 302, they are distributed in different directions and thus generate diffuse light.

The conversion element 303 comprises a conversion material. In particular, the conversion material is in the form of a ceramic platelet. The diffuser element 302 is arranged between the conversion element 303 and the output coupling element 301.

An optical element 40 is arranged downstream of the conversion structures 30. The optical element 40 is radiation permeable for the electromagnetic radiation emerging from the conversion structures 30. For example, the optical element is a projection lens.

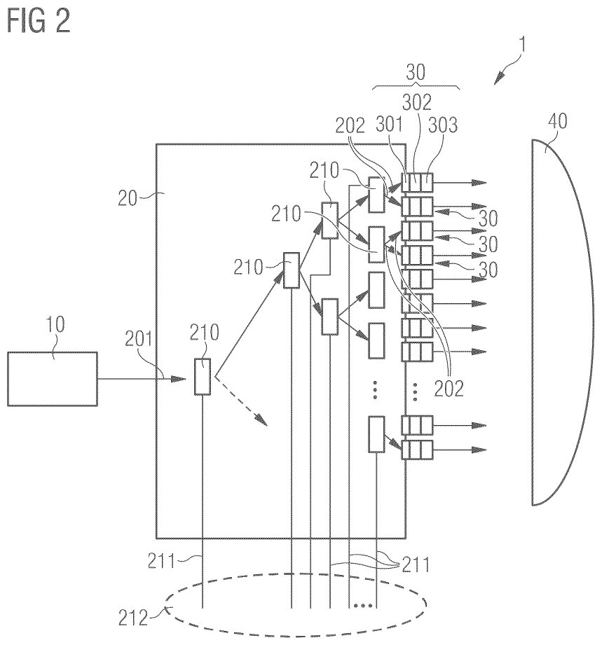

FIG. 2 shows a schematic sectional view of an optoelectronic module 1 described herein according to a second exemplary embodiment. The optoelectronic module 1 comprises a semiconductor component 10 configured to emit electromagnetic radiation. The semiconductor component 10 is configured to emit coherent radiation with a main wavelength in the blue spectral range. In particular, the main wavelength is greater than or equal to 440 nm and less than or equal to 475 nm. Preferably, the main wavelength is less than or equal to 465 nm.

Furthermore, the optoelectronic module 1 comprises a distribution structure 20 with a plurality of distribution elements 210, at least one input waveguide 201 and a plurality of output waveguides 202. The distribution structure 20 comprises a planar waveguide structure. This enables a particularly compact design with advantageously low optical coupling losses. The distribution structure 20 is configured to distribute electromagnetic radiation from the at least one input waveguide 201 to the output waveguides 202 in a predetermined intensity ratio. The electromagnetic radiation emitted by the semiconductor component 10 enters the distribution structure 20 through the input waveguide 201. The electromagnetic radiation then exits the distribution structure 20 through the output waveguide 202.

The distribution elements 210 are active and controllable coupling elements. Active distribution elements 210 are advantageously particularly precisely controllable. For example, the distribution elements 210 are designed as controllable directional couplers or as controllable directional couplers with phase reversal. A controllable directional coupler with phase reversal has an advantageously high tolerance to manufacturing fluctuations.

In particular, each distribution element 210 comprises a Mach-Zehnder interferometer. Advantageously, the distribution elements 210 are designed as electro-optically controllable components. In other words, an intensity distribution on the outputs of a distribution element 210 can be adjusted by means of an electrical control signal.

A control line 211 is assigned to each distribution element 210. The optoelectronic module 1 further comprises a control device 212, which is connected to the control lines 211. Via the control lines 211, each distribution element 210 can be controlled by the control device 212 independently of the other distribution elements 210. The control device can set a division ratio of each distribution element independently of one another by applying suitable electrical potentials.

The distribution elements 210 can be modulated with a frequency of at least 0.5 GHz, preferably 1 GHz, particularly preferably 10 GHz. Modulation of a distribution element 210 is defined here and in the following as a complete switching process, i.e. a complete switching from a first output to a second output of a distribution element. A particularly high modulation frequency enables an advantageously increased number of output waveguides 202, which can be controlled within a predetermined display period TD.

Furthermore, the optoelectronic module 1 comprises a plurality of conversion structures 30. The conversion structures 30 are arranged downstream of the distribution structure 20. The conversion structures 30 are configured to convert electromagnetic radiation of a first wavelength to electromagnetic radiation of a second wavelength different from the first wavelength. The conversion structures 30 effect, for example, a partial or complete conversion of the incoming electromagnetic radiation. Advantageously, the main wavelength of the semiconductor component 10 is selected such that it serves as an efficient pump wavelength for the conversion structure 30.

Each conversion structure 30 comprises an output coupling element 301, a diffuser element 302 and a conversion element 303. The output coupling element 301 is an optical grating coupler. Grating couplers enable an advantageously high efficiency with which electromagnetic radiation is coupled out of a waveguide into a region.

The diffuser element 302 is arranged downstream of the output coupling element 301. In particular, the diffuser element 302 homogenizes electromagnetic radiation emerging from the output coupling element 301. For example, the diffuser element 302 has a large number of small scattering centers. If parallel light rays hit different points of the diffuser element 302, they are distributed in different directions and thus generate diffuse light.

The conversion element 303 comprises a conversion material. In particular, the conversion material is in the form of a ceramic platelet. The diffuser element 302 is arranged between the conversion element 303 and the output coupling element 301.

An optical element 40 is arranged downstream of the conversion structures 30. The optical element 40 is radiation permeable for the electromagnetic radiation emerging from the conversion structures 30. For example, the optical element is a projection lens.

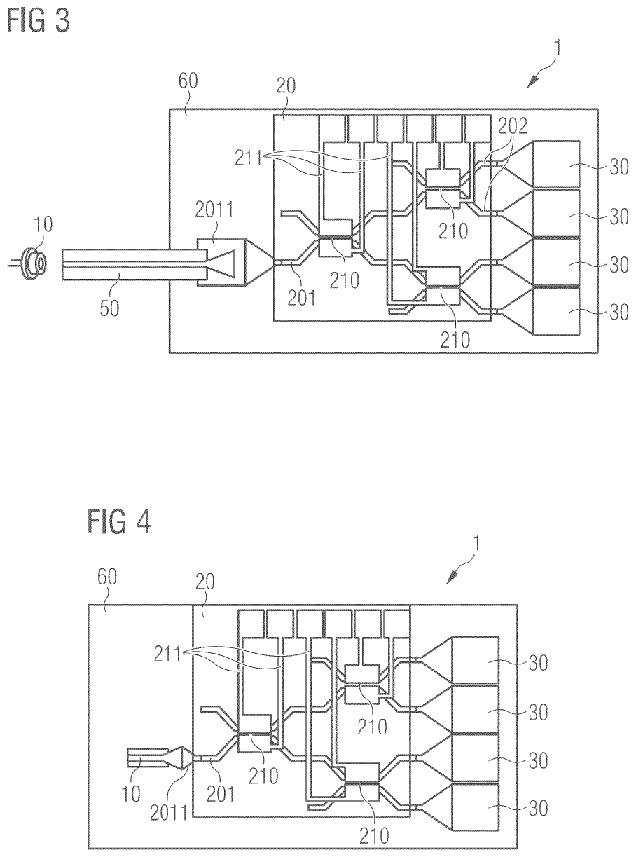

FIG. 3 shows a schematic top view of an optoelectronic module 1 described here according to a third exemplary embodiment. The third exemplary embodiment essentially corresponds to the second exemplary embodiment shown in FIG. 2. The distribution structure 20, the conversion structures 30 and an input coupling element 2011 are arranged on a common carrier 60. The carrier 60 is formed, for example, with one of the following materials: III/V semiconductor compound material, silicon on an insulator (silicon-on-insulator, abbreviated SOI), silicon dioxide, silicon nitride, indium phosphide, gallium arsenide, diamond, diamond on an insulator (diamond-on-insulator, abbreviated DOI), lithium niobate, aluminum oxide, aluminum nitride, gallium nitride.

The input coupling element 2011 is assigned to the input waveguide 201. The input coupling element 2011 is designed as a grid coupler. The semiconductor component 10 is optically connected to the input coupling element 2011 via an optical waveguide 50. In other words, the electromagnetic radiation from the semiconductor component 10 first enters the optical waveguide 50 and is then coupled in from the optical waveguide 50 into the input waveguide 201 via the input coupling element 2011. In particular, the input coupling element 2011 enables improved coupling efficiency between the semiconductor component 10 and the input waveguide 201.

FIG. 4 shows a schematic top view of an optoelectronic module 1 described here according to a fourth exemplary embodiment. The fourth exemplary embodiment essentially corresponds to the third exemplary embodiment shown in FIG. 3. In contrast to the third exemplary embodiment, the semiconductor component 10 is arranged on the carrier 60. In this way, a particularly compact optoelectronic module 1 can be provided.

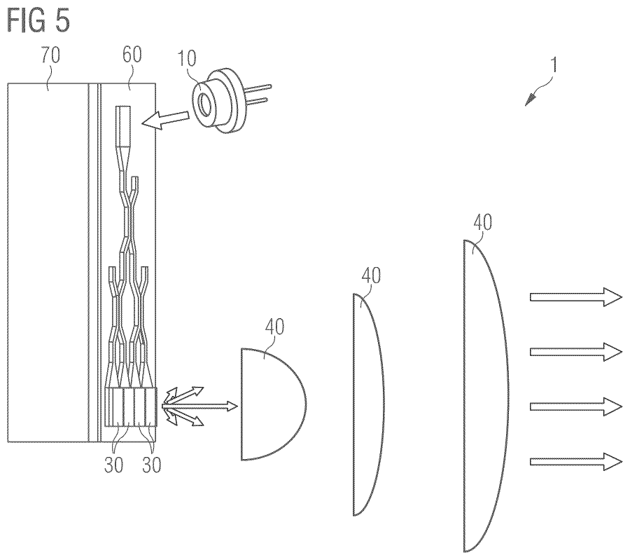

FIG. 5 shows a perspective schematic sectional view of an optoelectronic module 1 described here according to a fifth exemplary embodiment. The fifth exemplary embodiment essentially corresponds to the third exemplary embodiment shown in FIG. 3. In addition, a heat sink 70 is arranged on a rear side of the carrier 60. The heat sink 70 enables efficient dissipation of heat from the conversion structures 30. The heat sink 70 is formed with a material that has a particularly high heat conductivity, for example with a metal or a ceramic.

Furthermore, a plurality of optical elements 40 are arranged downstream of the conversion structures 30. The optical elements 40 are designed for beam shaping. The optical elements are formed in particular with a radiation permeable polymer, for example polymethyl methacrylate, PMMA for short, or a glass. Advantageously, the optical elements 40 cause a collimation of the electromagnetic radiation emerging from the conversion structures 30.

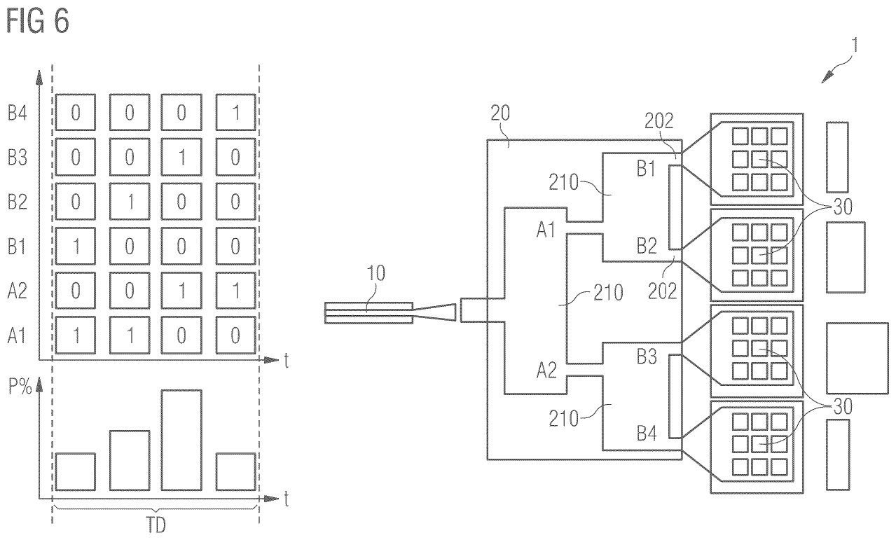

FIG. 6 shows a control concept of an optoelectronic module 1 described here according to a first exemplary embodiment. An optoelectronic module 1 with a semiconductor component 10 and a distribution structure 20 is controlled. The semiconductor component 10 emits electromagnetic radiation with a constant main wavelength in the visible spectral range. The distribution structure 20 comprises a plurality of active and controllable distribution elements 210. The distribution elements 210 each have an input and two outputs. The outputs of the distribution elements 210 are provided with unique designations A1, A2, B1, B2, B3 and B4.

The control concept shows a course of the control of all outputs A1, A2, B1, B2, B3 and B4 of the distribution elements 210 and the optical output power of the semiconductor component 10 over a display period TD.

The display period TD describes a period of time in which a desired intensity distribution of the electromagnetic radiation is provided at the output waveguides 202. Advantageously, the display period TD is so short that no impression of flickering is created for a human observer. For example, the display period TD is at most 1/30 s, preferably at most 1/60 s and particularly preferably at most 1/100 s long.

The distribution elements 210 act as optical switches. In the display period TD, the distribution elements 210 are switched several times. The value “1” means that this output is active and electromagnetic radiation is emitted at this output. The value “0” means that this output is not active and no electromagnetic radiation is emitted at this output. At a first point in time within the display period TD, the outputs A1 and B1 of the distribution elements 210 are active. Consequently, electromagnetic radiation emerges at the uppermost output waveguide 202 and is emitted by the uppermost conversion structure 30. The distribution elements 210 are modulated with a frequency of at least 0.5 GHz, preferably at least 1 GHz, particularly preferably at least 10 GHz.

The optical output power of the semiconductor component 10 is modulated synchronously with the distribution elements 210 in the display period TD. In this way, each output waveguide 202 can be illuminated with a desired intensity distribution by selective control of the distribution elements 210.

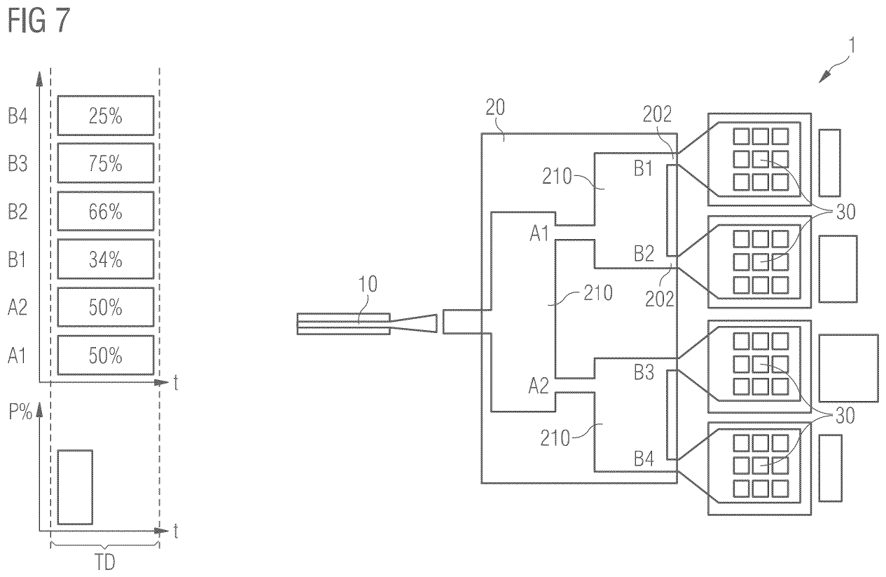

FIG. 7 shows a control concept of an optoelectronic module 1 described here according to a second exemplary embodiment. The structure of the controlled optoelectronic module 1 essentially corresponds to the optoelectronic module 1 shown in FIG. 6. In contrast to the control concept shown in FIG. 6, an optical output power of the semiconductor component 10 is constant in the display period TD. The distribution elements 210 act as variably modulatable beam splitters, the distribution of which is constant over the display period TD.

The first distribution element 210 with outputs A1 and A2 is controlled in such a way that 50% of the irradiated intensity is distributed to output A1 and 50% of the irradiated intensity is distributed to output A2. In the downstream distribution element with outputs B1 and B2, 34% of the radiated intensity is distributed to output B1 and the remaining 66% of the radiated intensity is distributed to output B2. This results in a desired intensity distribution at the output waveguide 202.

Advantageously, multiple switching operations of the distribution elements 210 within the display period TD can thus be dispensed with. Furthermore, modulation of the optical output power of the semiconductor component 10 can be dispensed with. The semiconductor component 10 is in cw mode.

In addition, an output waveguide 202 can be provided in the distribution structure 20 as a light sink. Excess optical power can thus be absorbed in the light sink.

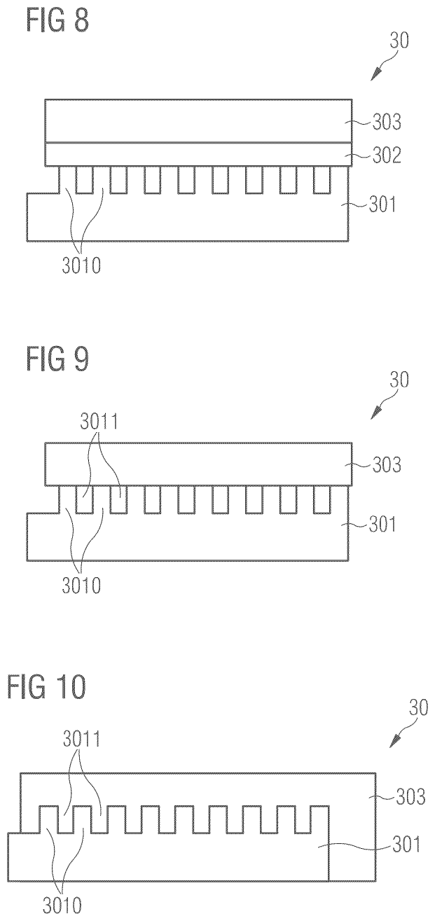

FIG. 8 shows a schematic sectional view of a conversion structure 30 described here according to a first exemplary embodiment. The conversion structure 30 comprises an output coupling element 301, a diffuser element 302 and a conversion element 303. The output coupling element 301 is, for example, an optical grating coupler. Grating couplers enable an advantageously high efficiency with which electromagnetic radiation is decoupled from a waveguide into a range. The output coupling element 301 has a structuring with a plurality of elevations 3010 and depressions 3011 on a side facing the diffuser element 302.

The diffuser element 302 is arranged between the output coupling element 301 and the conversion element 303. The diffuser element homogenizes electromagnetic radiation emerging from the output coupling element 301. The diffuser element 302 has a large number of scattering centers. If parallel light rays strike different points of the diffuser element 302, they are distributed in different directions and thus generate diffuse light.

The conversion element 303 contains a conversion material. In particular, the conversion material is in the form of a ceramic platelet. The conversion element 303 converts electromagnetic radiation of a first main wavelength λ₁ to electromagnetic radiation of a second main wavelength λ₂. In particular, the second main wavelength λ₂ is greater than the first main wavelength λ₁. For example, a first electromagnetic radiation is partially or completely converted. In the case of partial conversion, the conversion element 303 emits a mixed radiation of converted and unconverted electromagnetic radiation. The conversion element 303 is mechanically self-supporting.

FIG. 9 shows a schematic sectional view of a conversion structure 30 described here according to a second exemplary embodiment. The second exemplary embodiment essentially corresponds to the first exemplary embodiment shown in FIG. 8. In contrast to the first exemplary embodiment, the conversion structure 30 does not comprise a diffuser element 302. The conversion element 303 is arranged directly on the output coupling element 301. The conversion element 303 is mechanically self-supporting and rests on the elevations 3010 of the output coupling element 301.

FIG. 10 shows a schematic sectional view of a conversion structure 30 described here according to a third exemplary embodiment. The third exemplary embodiment essentially corresponds to the second exemplary embodiment shown in FIG. 9. In contrast to the second exemplary embodiment, the conversion element 303 is applied to the output coupling element 301 by means of spray coating. For example, the conversion element 303 is formed with a matrix material in which particles of a light-emitting substance are embedded. A radiation permeable polymer, for example a polysiloxane, is particularly suitable as a matrix material. The conversion element 303 extends into the depressions 3011 of the output coupling element 301. The conversion element 303 projects beyond the output coupling element 301 in a lateral direction. Advantageously, this results in a particularly good adhesion between the output coupling element 301 and the conversion element 303.

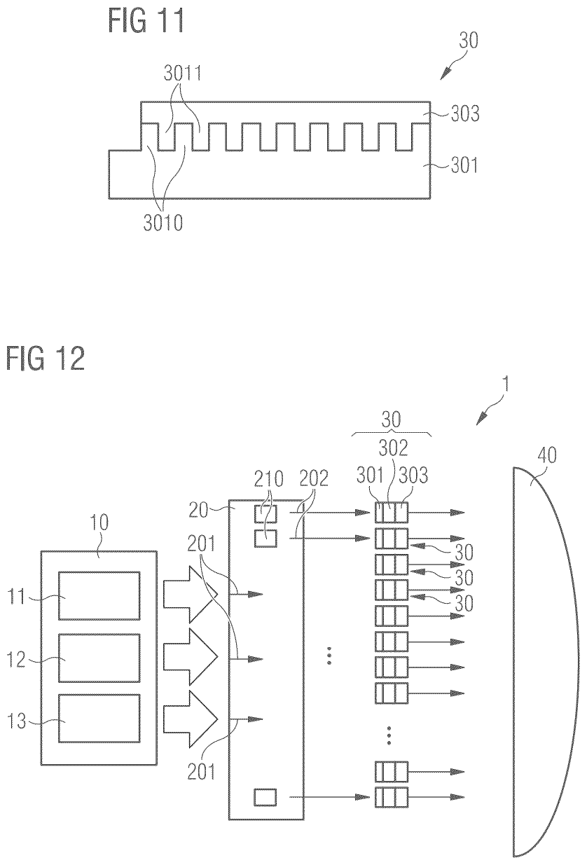

FIG. 11 shows a schematic sectional view of a conversion structure 30 described here according to a fourth exemplary embodiment. The fourth exemplary embodiment essentially corresponds to the third exemplary embodiment shown in FIG. 10. In contrast to the third exemplary embodiment, the conversion element 303 is structured. For example, the conversion element 303 is structured by means of photolithography. The lateral extent of the conversion element 303 corresponds to the lateral extent of the elevations 3010 of the structuring of the output coupling element 301.

FIG. 12 shows a schematic sectional view of an optoelectronic module 1 described here according to a sixth exemplary embodiment. The sixth exemplary embodiment essentially corresponds to the first exemplary embodiment shown in FIG. 1. In contrast to the first exemplary embodiment, the semiconductor component 10 comprises a plurality of semiconductor emitters 11, 12, 13. A first semiconductor emitter 11 emits electromagnetic radiation with a variable first main wavelength λ₁ in a first spectral range, a second semiconductor emitter 12 emits electromagnetic radiation with a variable second main wavelength λ₂ in a second spectral range and a third semiconductor emitter 13 emits electromagnetic radiation with a variable third main wavelength λ₃ in a third spectral range.

The first main wavelength λ₁, the second main wavelength λ₂ and the third main wavelength λ₃ are different from each other. Preferably, the spectral ranges of the first electromagnetic radiation, the second electromagnetic radiation and the third electromagnetic radiation do not overlap. By using a plurality of semiconductor emitters 11, 12, 13, the semiconductor component 10 can emit electromagnetic radiation over a wider bandwidth.

Alternatively, the first, second and third main wavelengths λ₁, λ₂, λ₃ are identical. If a separate input waveguide 201 is assigned to each semiconductor emitter 11, 12, 13, a distinction between the first, second and third main wavelengths λ₁, λ₂, λ₃ can be dispensed with. Advantageously, this allows a particularly small deviation of the emission wavelength in the individual output waveguides 202.

An input waveguide 201 is assigned to each semiconductor emitter 11, 12, 13. Advantageously, a required number of distribution elements 210 in the distribution structure 20 can thus be reduced. For example, a first number of output waveguides 202 are assigned to the first semiconductor emitter 11, a second number of output waveguides 202 are assigned to the second semiconductor emitter 12 and a third number of output waveguides 202 are assigned to the third semiconductor emitter 13.

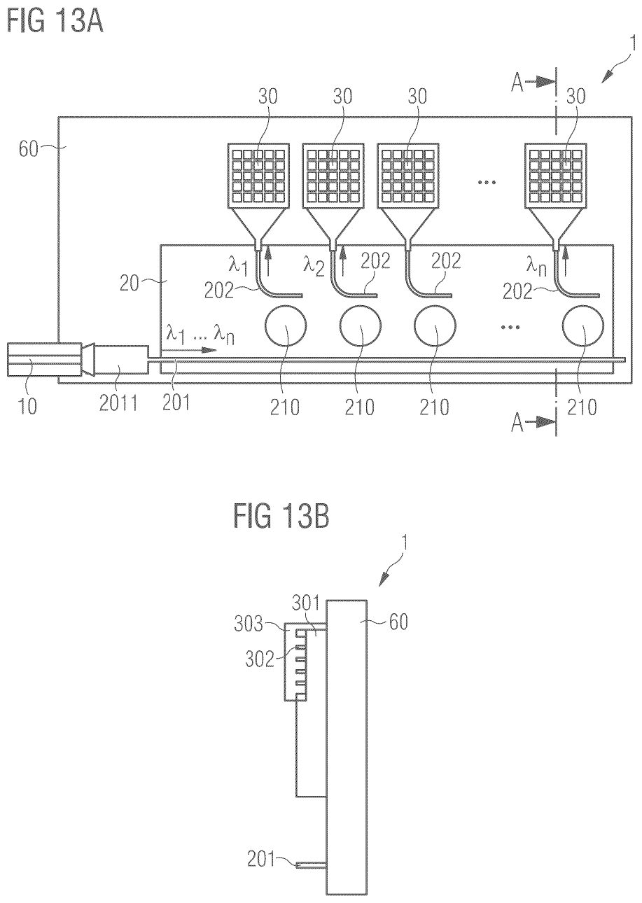

FIG. 13A shows a schematic top view of an optoelectronic module 1 described here according to a seventh exemplary embodiment. The seventh exemplary embodiment essentially corresponds to the first exemplary embodiment shown in FIG. 1. The distribution elements 210 are designed as microring resonators. Electromagnetic radiation with different main wavelengths λ₁ to λₙ is emitted from the optoelectronic semiconductor component 10. Each distribution element 210 has a passband for one of the main wavelengths λ₁ to λₙ. A distribution element 210 is assigned to each output waveguide 202.

The distribution structure 20, the conversion structures 30 and an input coupling element 2011 are arranged on a common carrier 60. The carrier 60 is formed, for example, with one of the following materials: III/V semiconductor compound material, silicon on an insulator (silicon-on-insulator, abbreviated SOI), silicon dioxide, silicon nitride, indium phosphide, gallium arsenide, diamond, diamond on an insulator (diamond-on-insulator, abbreviated DOI), lithium niobate, aluminum oxide, aluminum nitride, gallium nitride.

FIG. 13B shows a schematic sectional view of an optoelectronic module 1 described herein according to the seventh embodiment. FIG. 13B shows a sectional view through FIG. 13A along the sectional line AA. In the sectional view, the structure of the conversion structure 30 is recognizable. A diffuser element 302 is arranged between a conversion element 303 and an output coupling element 301. The input waveguide 201 is arranged on the carrier 60.

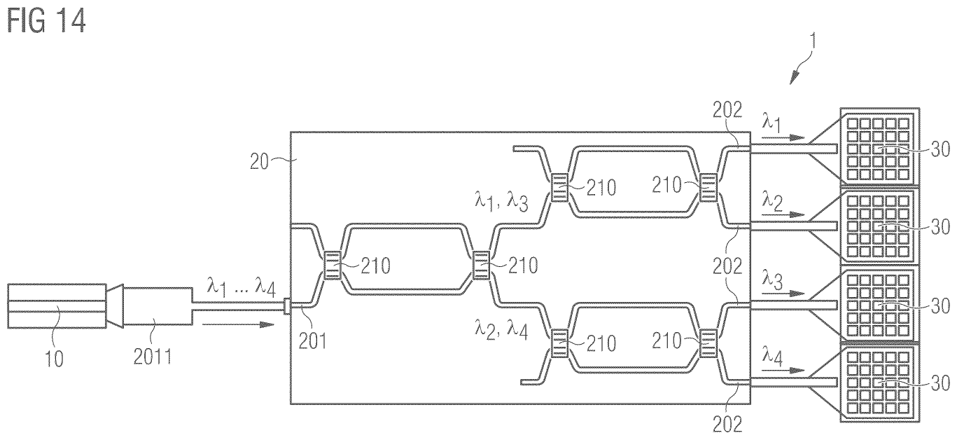

FIG. 14 shows a schematic top view of an optoelectronic module 1 described here according to an eighth exemplary embodiment. The eighth exemplary embodiment essentially corresponds to the third exemplary embodiment shown in FIG. 3. In contrast to the third exemplary embodiment, the distribution structure 20 are passive, wavelength-selective filter elements. In particular, the distribution elements 210 are designed as passive Mach-Zehnder interferometers. Since interferometers are wavelength-sensitive, they are suitable for wavelength division multiplexing. A Mach-Zehnder interferometer can be used as a two-wavelength demultiplexer. In order to route the components of the wavelengths λ₁ and λ₂ to different outputs, the difference Δd of the path lengths is selected so that the phase difference ϕ=2πd/λ is an even multiple of π for λ₁ and an odd multiple of π for λ₂. This means Δd=q₁*λ₁/2 or Δd=q₂*λ₂/2, where q₁ is an even integer and q₂ is an odd integer. Several Mach-Zehnder interferometers can be used in series to separate more than two wavelengths.

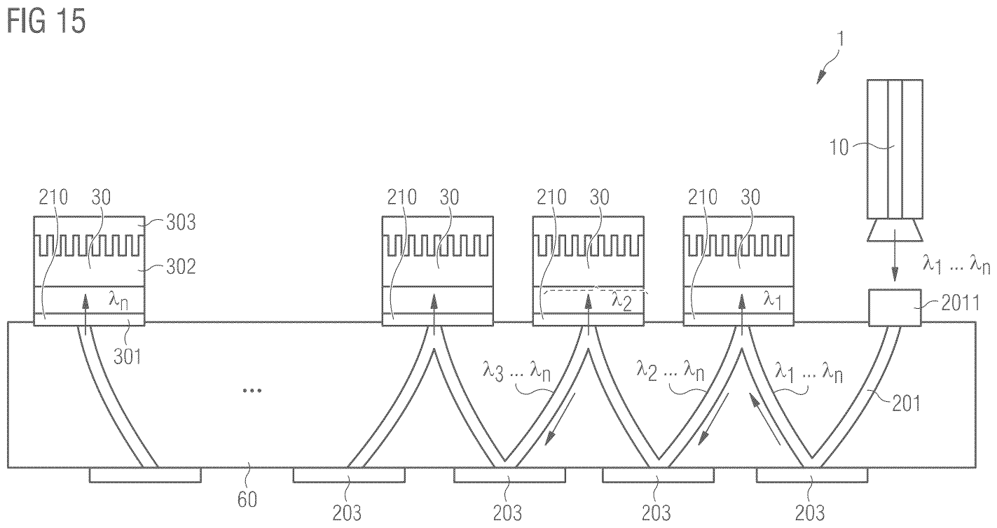

FIG. 15 shows a schematic top view of an optoelectronic module 1 described here according to a ninth exemplary embodiment. The ninth exemplary embodiment essentially corresponds to the first exemplary embodiment shown in FIG. 1. The distribution elements 210 are designed as interference thin-film filters. The distribution elements 210 and a plurality of reflectors 203 are arranged on a carrier 60. The reflectors 203 are formed, for example, with a broadband reflective material, in particular silver. The carrier 60 is designed as a gradient index rod.

The main wavelengths λ₁ to λₙ are separated by an arrangement of different filters. The incident electromagnetic radiation is directed onto the filters, each of which allows a single main wavelength to pass and blocks the others. The incident electromagnetic radiation is guided through a sequence of narrow-band interference thin-film filters, each of which transmits one wavelength in a passband and reflects all other wavelengths onto the following filter.

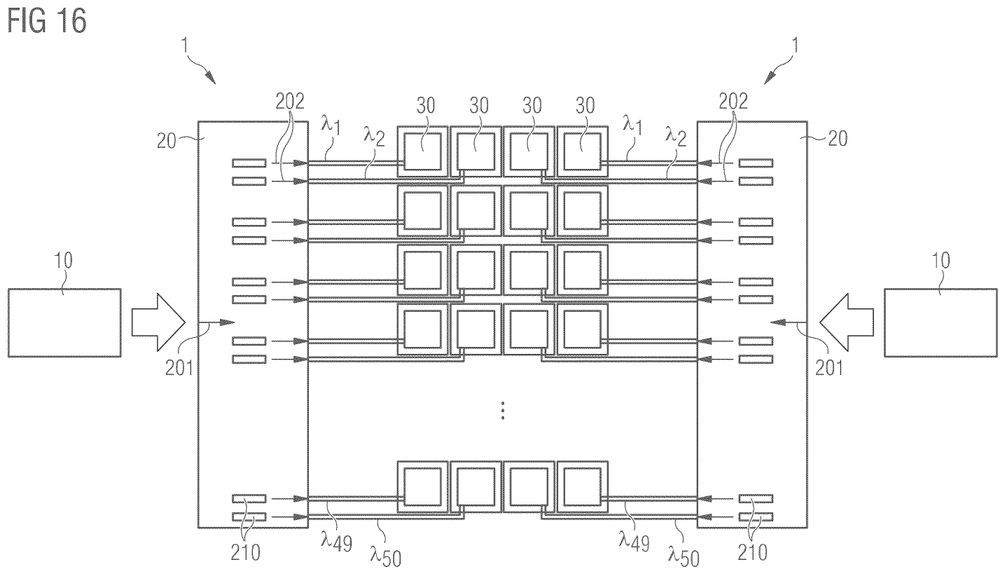

FIG. 16 shows a schematic sectional view of a device with a plurality of optoelectronic modules 1 described herein according to a tenth exemplary embodiment. Two optoelectronic modules 1 are arranged in such a way that the conversion structures 30 of the two optoelectronic modules 1 are adjacent to each other.

The optoelectronic modules 1 are essentially identical to the exemplary embodiment of an optoelectronic module shown in FIG. 1. The use of several optoelectronic modules 1 makes it particularly easy to scale the number of controllable conversion structures 30. Preferably, the optoelectronic modules used are of identical design.

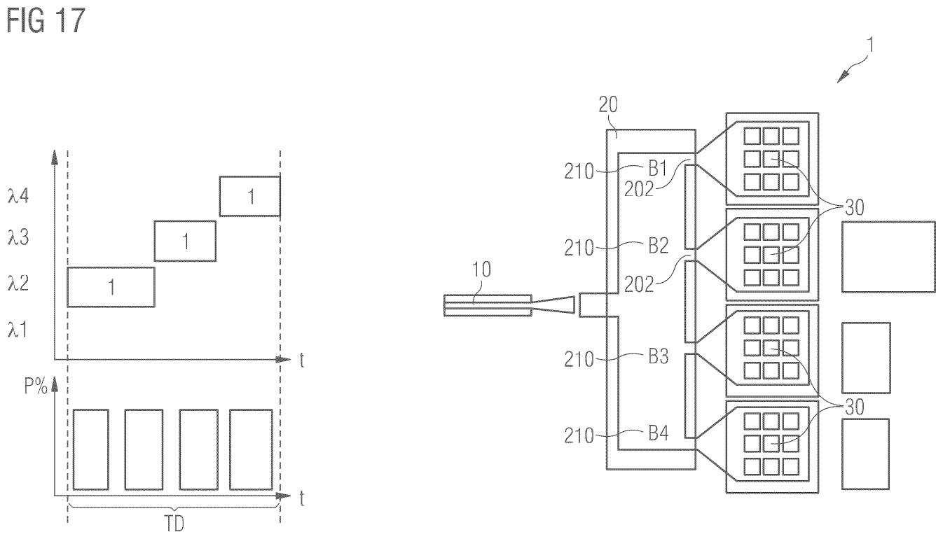

FIG. 17 shows a control concept of an optoelectronic module 1 described here according to a third exemplary embodiment. An optoelectronic module 1 with a semiconductor component 10 and a distribution structure 20 is controlled. The semiconductor component 10 emits electromagnetic radiation with different discrete main wavelengths, preferably in the visible spectral range. The distribution structure 20 comprises a plurality of distribution elements 210, which are provided as passive and wavelength-selective filter elements. The distribution elements 210 each have an output. The outputs of the distribution elements 210 are provided with unique designations B1, B2, B3 and B4.

The control concept shows a course of the main wavelength λ₁ to λ₄ emitted by the semiconductor component 10 and the optical output power of the semiconductor component 10 over a display period TD. The display period TD describes a time period in which a desired intensity distribution of the electromagnetic radiation is provided at the output waveguides 202. Advantageously, the display period TD is so short that no impression of flickering is created for a human observer. For example, the display period TD is at most 1/30 s, preferably at most 1/60 s and particularly preferably at most 1/100 s long.

The optical output power of the semiconductor component 10 is constant in the display period TD.

In the display period TD, different main wavelengths λ₁ to λ₄ are emitted for a period of time dependent on the main wavelength. Only the distribution element 210 with the output B2 is permeable to electromagnetic radiation with the second main wavelength Az. Consequently, electromagnetic radiation emerges from above at the second output waveguide 202 and is emitted by the downstream conversion structure 30. Thus, by selectively changing the main wavelength emitted from the semiconductor component 10, each output waveguide 202 can be illuminated with a desired intensity distribution.

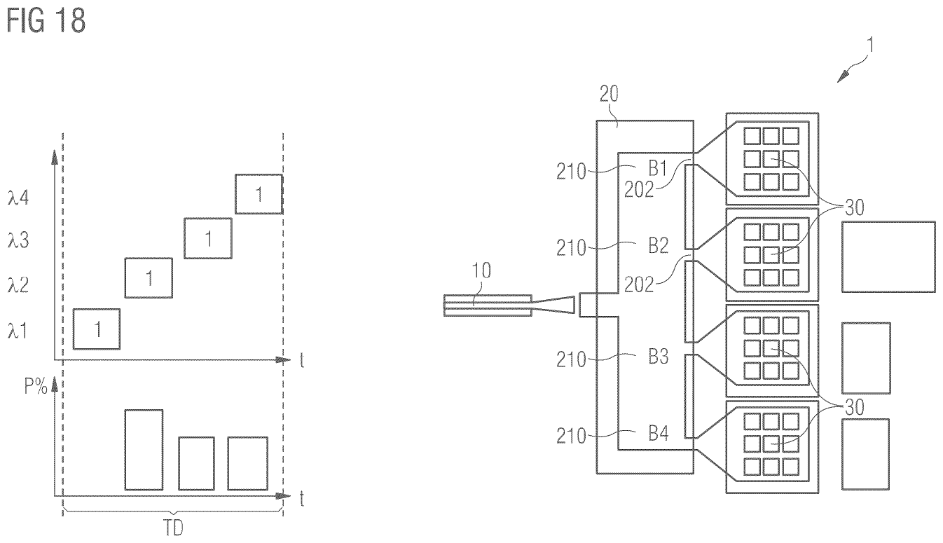

FIG. 18 shows a control concept of an optoelectronic module 1 described here according to a fourth exemplary embodiment. The structure of the controlled optoelectronic module 1 essentially corresponds to the optoelectronic module 1 shown in FIG. 17. In contrast to the control concept shown in FIG. 17, an optical output power of the semiconductor component 10 is modulated in the display period TD.

In the display period TD, different main wavelengths are emitted for an identical period in each case. Advantageously, a rate of change of the main wavelength can thus be set constantly. The optical output power of the semiconductor component 10 is modulated synchronously with the modulation of the main wavelengths in the display period TD. For example, the semiconductor component 1 does not emit electromagnetic radiation at the first main wavelength to consequently not illuminate the output waveguide 202 with the output B1. A desired intensity distribution at the output waveguides 202 can thus be achieved by modulating the output power of the semiconductor component 10.

The invention is not limited by the description based on the exemplary embodiments. Rather, the invention includes any new feature as well as any combination of features, which includes in particular any combination of features in the patent claims, even if this feature or combination itself is not explicitly stated in the patent claims or embodiments.

1. An optoelectronic module comprising:
a semiconductor component configured to emit electromagnetic radiation,
a distribution structure comprising a plurality of distribution elements, at least one input waveguide and a plurality of output waveguides, and
a plurality of conversion structures, wherein
the distribution elements, the at least one input waveguide and the output waveguides are monolithically integrated on a substrate,
the electromagnetic radiation emitted by the semiconductor component enters the distribution structure through the input waveguide,
the electromagnetic radiation exits the distribution structure through the output waveguides, and
a conversion structure is arranged downstream of each output waveguide and configured to convert electromagnetic radiation of a first wavelength to electromagnetic radiation of a second wavelength different from the first wavelength.

2. The optoelectronic module according to the claim 1, wherein the distribution elements are passive and wavelength-selective filter elements.

3. The optoelectronic module according to claim 2, wherein the distribution elements have a passband with a bandwidth of at most 2 nm, preferably at most 1 nm.

4. The optoelectronic module according to claim 2, wherein the semiconductor component is configured to emit coherent radiation having a modulatable main wavelength.

5. The optoelectronic module according to claim 4, wherein the main wavelength of the electromagnetic radiation emitted by the semiconductor component can be modulated in a spectral range over a bandwidth of at least 25 nm, preferably of at least 50 nm and particularly preferably of at least 100 nm, the spectral range including a wavelength of 447 nm.

6. The optoelectronic module according to claim 5, wherein the main wavelength can be modulated with a frequency of at least 500 Hz, preferably at least 1 kHz and particularly preferably at least 2 kHz.

7. The optoelectronic module according to claim 2, wherein the semiconductor component comprises at least two semiconductor emitters, wherein the first semiconductor emitter is configured to emit an electromagnetic radiation having a variable main wavelength in a first spectral range and a second semiconductor emitter is configured to emit an electromagnetic radiation having a variable main wavelength in a second spectral range.

8. The optoelectronic module according to claim 7, in which an input waveguide is assigned to each semiconductor emitter.

9. The optoelectronic module according to claim 2, wherein exactly one distribution element is assigned to each output waveguide.

10. The optoelectronic module according to claim 1, wherein the distribution elements are active and controllable coupling elements.

11. The optoelectronic module according to claim 10, wherein the distribution elements can be modulated with a frequency of at least 0.5 GHz, preferably 1 GHz, particularly preferably 10 GHz.

12. The optoelectronic module according to claim 10, wherein the semiconductor component is configured to emit coherent radiation having a main wavelength in the blue spectral range.

13. The optoelectronic module according to claim 1, wherein each conversion structure comprises an output coupling element.

14. The optoelectronic module according to claim 1, wherein each conversion structure comprises a diffuser element.

15. The optoelectronic module according to claim 1, wherein an input coupling element is associated with each input waveguide.

16. The optoelectronic module according to claim 1, wherein the semiconductor component is formed with a III/V semiconductor compound material.

17. The optoelectronic module according to claim 1, wherein the distribution structure is formed with one of the following materials: III/V semiconductor compound material (in particular identical to the semiconductor component), silicon-on-insulator (SOI), silicon dioxide, silicon nitride, indium phosphide, gallium arsenide, diamond, diamond-on-insulator (DOI), lithium niobate, aluminum oxide, aluminum nitride, gallium nitride.

18. The optoelectronic module according to claim 1, wherein the optoelectronic module comprises at least 10, preferably at least 30, particularly preferably at least 100 output waveguides.

19. A method for operating an optoelectronic module according to claim 1, wherein
the distribution elements are provided as passive and wavelength-selective filter elements,
the semiconductor component emits electromagnetic radiation with different discrete main wavelengths, wherein
different main wavelengths are emitted in a display period for a time period dependent on the main wavelength in each case, and
an optical output power of the semiconductor component is constant in the display period, or wherein
different main wavelengths are emitted in a display period for an identical period in each case, and
an optical output power of the semiconductor component is modulated in the display period in synchronization with the modulation of the main wavelengths.

20. The method for operating an optoelectronic module according to claim 1, wherein
the distribution elements are provided as active and controllable coupling elements,
the semiconductor component emits electromagnetic radiation with a constant main wavelength, wherein
an optical output power of the semiconductor component is constant in a display period, and
the distribution elements act as variably modulatable beam splitters, the distribution of which is constant over the display period, or wherein
the distribution elements act as optical switches and are switched several times in a display period, and
an optical output power of the semiconductor component is modulated in synchronization with the distribution elements in the display period.
